(19) United States
(12) Patent Application Publication
(10) Pub. No.: US 2014/0019112 A1
(43) Pub. Date: Jan. 16, 2014

(54) SYNTHESIS OF SIMULATION MODELS FROM SYSTEMS ENGINEERING DATA

(71) Applicants: Arquimedes Martinez Canedo, Princeton, NJ (US); Dmitriy Okunev, Lawrenceville, NJ (US)

(72) Inventors: Arquimedes Martinez Canedo, Princeton, NJ (US); Dmitriy Okunev, Lawrenceville, NJ (US)

(73) Assignee: Siemens Product Lifecycle Management Software Inc., Plano, TX (US)

(21) Appl. No.: 13/933,615

(22) Filed: Jul. 2, 2013

Related U.S. Application Data
(60) Provisional application No. 61/669,863, filed on Jul. 10, 2012.

(51) Int. Cl. G06F 17/50

(52) U.S. Cl. CPC G06F 17/5009
USPC 703/21

(57) ABSTRACT

Methods for product data management and corresponding systems and computer-readable mediums. A method includes receiving systems engineering data including a plurality of components and identifying interfaces from the plurality of components. The method includes synthesizing a network between the plurality of components. The method includes creating a simulation model, based on the network, by mapping the plurality of components to a corresponding plurality of simulation components and generating a simulation and control code according to the simulation model and the simulation components.

### CROSS-REFERENCE TO OTHER APPLICATION

This application claims the benefit of the filing date of U.S. Provisional Patent Application 61/669,863, filed Jul. 10, 2012, which is hereby incorporated by reference.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or “PDM” systems).

### BACKGROUND OF THE DISCLOSURE

PDM systems manage PLM and other data. Improved systems are desirable.

### SUMMARY OF THE DISCLOSURE

Various disclosed embodiments include methods for product data management and corresponding systems and computer-readable mediums. A method includes receiving systems engineering data including a plurality of components and identifying interfaces from the plurality of components. The method includes synthesizing a network between the plurality of components. The method includes creating a simulation model, based on the network, by mapping the plurality of components to a corresponding plurality of simulation components and generating a simulation and control code according to the simulation model and the simulation components.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 illustrates elements and interactions of disclosed embodiments;

FIG. 3 illustrates a flowchart of a process in accordance with disclosed embodiments; and

FIGS. 4A-4E illustrate examples of models in accordance with disclosed embodiments.

### DETAILED DESCRIPTION

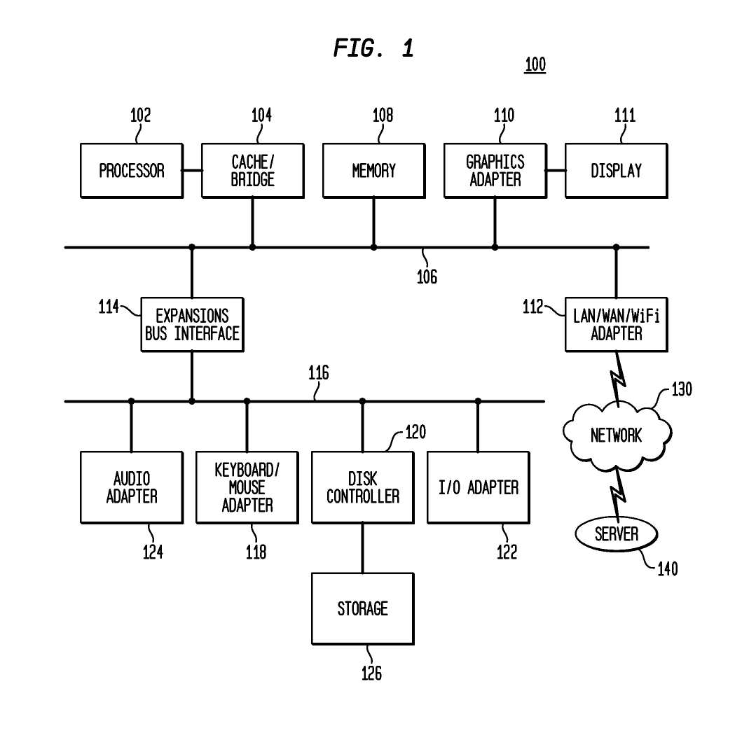

FIGS. 1 through 4E, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In general, mechatronics refers to the synergistic combination of mechanical engineering, electrical/electronic engineering, computer engineering, control engineering, systems design engineering, and other technical disciplines to create, design, and manufacture useful products. The concept phase in the overall design process of a mechatronics system is the first time where the architect thinks about the physical implementation. The architect must ensure that the implementation is conformant with the requirements and has a basic design structure that enables an efficient detailed design and production.

Some systems are capable of maintaining requirements, functions, and disciplinary data in a data base. One can match the various data structures by creating a link between items in the data base from a pure data point of view. There is no specific design context for interdisciplinary concept design in conventional systems.

In conventional systems each item has a specific design context which makes the design of multi-disciplinary product designs hard to grasp for designers/engineers. Prior systems just examine items as data objects that can be managed in a data base. This makes it impossible to support a creative design process required to produce a mechatronics concept design.

Mechatronic models, as used herein, can store the functional model which provides a discipline-independent definition of a system's functions which can be mapped to multiple disciplines for implementation. A function-based mechatronics object can capture and effectively reuse all data that are relevant to design the concept of a mechatronics system in one file. Such a mechatronics object can include data for 3D design including sub-assemblies, kinematics, and dynamics, logical behavior of the object including programming code, sensors and actuators to control the unit, sequence of operations (offering the capability of the “compound” operation), continuous behavior described in continuous functions, and other data as described herein. Such a mechatronics object can then be used to generate PLC code as descried herein.

A mechatronic object can include a functional decomposition that describes one or more functions of the object. For example, a functional decomposition for a gripper could include a main function of “gripper unit”, and subfunctions of “move vertically” and “grip gear”. The mechatronic object can be used to store functional components such as the discipline-independent aspects of the system defining what functions must be implemented by the different discipline specific models, and does not necessarily carry the details of a single specific implementation of each function.

A mechatronic object can include rough geometries or sub-assemblies for the object, and can include physics information for the object. A mechatronic object can include actuator/sensor and other information for the object. A mechatronic object can include mechanical interfaces, electrical interfaces, pneumatic interfaces, programming interfaces, and other interfaces for the object. A mechatronic object can include operations data and other information for the object.

Disclosed embodiments include systems and methods for synthesizing correct and complete simulation models from systems engineering data including functional or logical models. Simulation models can be used that include techniques used by the Simulink® software environment by MathWorks, Inc. of Natick, Mass., the Modelica® language by the Modelica Association of Linköping, Sweden, the VHSIC Hardware Description Language (VHDL), queuing systems, control code, numerical simulation models, and others. Systems engineering data typically includes RFLP (Requirements Functional Logical Physical) models. Disclosed embodiments can synthesize correct and complete simulation code from RFLP models. More importantly, depending on the user needs and the stage of development of a product, different types of simulation varying in detail, fidelity, and level of abstraction are automatically generated from the same RFLP models. Disclosed embodiments can generate simulation code for both plants (system under control) and controllers. This code can be used later for generating production embedded code or PLC code.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware illustrated in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

As described above, disclosed embodiments can produce correct and complete system simulation code from RFLP models. The modeled system can be, for example, a product, a product's module, a plant (a system under control), a controller, or a combination of these. “Correct simulation code,” as used herein, refers to a simulation that takes into consideration not only the system or subsystem under test but its context or environment, e.g., the physical environment in which it operates, other systems with which it may interact, or others. “Complete simulation code,” as used herein, refers to a simulation that does not require any manual modifications to test the system or one of its subsystems.

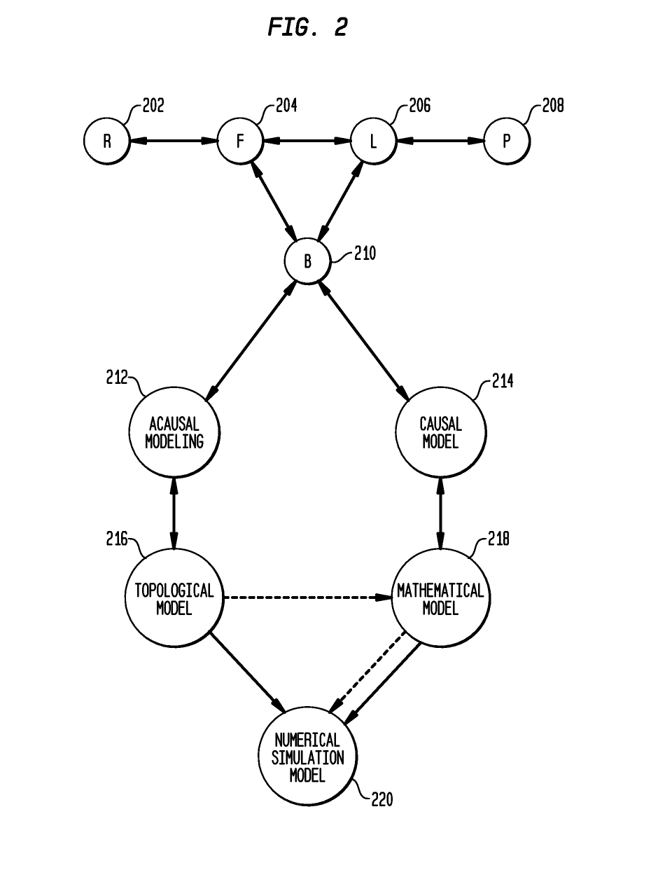

FIG. 2 illustrates elements and interactions of disclosed embodiments, in conjunction with the description below.

Various embodiments enable validation and verification of requirement, functional, logical, and physical models in the synthesized simulation code. Various embodiments enable synthesis and selection of alternative solutions based on the simulation results. The generation of simulation models can be performed according to a selected level of abstraction and design objectives. For example, an early concept simulation can be synthesized from the functional model that does not make any assumption about the implementation of the system and can provide a very high level of abstraction for the simulation. On the other hand, as engineering progresses, higher fidelity simulations can be synthesized from specific logical models to analyze each and every component in combination as a system or independently.

Disclosed embodiments can automatically generate simulation models from requirements, functional, logical, and physical (RFLP) data, and has particular use for automatic model generation for mechatronics. Changes in the RFLP data can be tested through simulation immediately because simulation models can be automatically generated rather than manually created. This eliminates the time consuming and error prone process of manual model generation.

Disclosed embodiments can ensure consolidation and availability of multiple applications of simulation from a single RFLP data source. These applications include high-fidelity multi-body simulation, hardware-in-the-loop simulation, software-in-the-loop simulation, model-in-the-loop simulation, material flow simulation, queuing simulation, validation of requirements through simulation, and control code generation.

Disclosed embodiments can use a free-form diagramming approach to describe hierarchical and layered RFLP models in a consistent and language-independent manner. These diagrams can then be synthesized to infer the hierarchy, architecture, interfaces, infrastructure, level of abstraction, and context of the simulation code for plants and controllers. The result of this method is to extend the systems modeling engineering processes, such as RFLP, with an intelligent integration of commercial simulation tools by providing a powerful behavior generation capabilities from the Logical model within the RFLP.

In RFLP, Requirements models 202 provide the user and regulatory requirements in a formal way, and describe what the system must do to satisfy its customers and stakeholders. Functional models 204 describe what the system is supposed to do. Although functional models can be represented through various notations, a directed graph can be used where nodes are function-performing elements and the edges represent the direction and type of flow between functions. Functions can be defined as the transformation of inputs into outputs. The inputs, transformations, and outputs may be implicit or explicit.

Logical models 206 are the realization of how components are interconnected, with physical connectors, in a topological schematic view. These models are sometimes called abstract-physical and represent an abstract networked product structure carrying all the logical data necessary to build a physical model. Physical models 208 define detailed specification for fabrication including dimensions, shapes, and source code. These models can be built using, for example, CAD systems and compilers.

The VDI 2206 Design Methodology for Mechatronic Systems, known to those of skill in the art, defines the various models used for simulation. Topological models 216 represent the “arrangement and interlinking of function performing elements.” These include state variables such as mass, length, resistances number of connections etc. For example, Modelica models are created on the principle of the physical interconnection of components. This is enabled by the acausal physical modeling paradigm and allows the modeler to concentrate on shape and structure rather than mathematical descriptions. The Simscape language is also an acausal physical modeling language.

Mathematical models 218 represent an abstract description of the physical models using mathematical descriptions. It is up to the modeler to define the fidelity and level of detail of the model. Simulink is a language that can be used to create mathematical models. The user is responsible for specifying the mathematical descriptions of functions, inputs, outputs, state variables, and to interconnect different functions together to create a mathematical model.

Numerical simulation models 220 are usually the result of discretizing mathematical models and coupling them with a numerical solver for simulation in a computer system.

Disclosed embodiments include processes to create simulation models from RFLP models by defining and gathering all formal simulation data from the logical model. This allows a dynamic generation of simulation code for various simulation environments. Disclosed embodiments includes systems and methods for validating and verifying requirement, functional, and logical component models and refining of the original RFLP in real-time using simulation code.

As used herein, an “Architecture model” represents the modules in which the system is supposed to be organized. This modularity facilitates the creation of subsystems that are easy to specify, construct, develop, test, verify, understand, modify, and maintain. These modules in the architecture model can be regarded as independent from one another because each module in the architecture model performs a well-defined set of functions, makes no assumptions about other modules in the architecture model, and has well defined interfaces. Architecture can also be used to identify groups of related functions or groups of unrelated functions. Architecture models usually separate the control tasks from physical tasks.

A “Behavior model” describes the dynamics of a system, or how the system evolves over time. Behavior can be continuous or discrete (as a set of events). Behavior models may be described by differential equations, mathematical formulas, state machines, block-flow diagrams, etc. In various embodiments, the system can infer behavior from the logical model (using also information from RFLP models) and automatically generate simulation code that describes behavior.

A “duality” refers to a pair of concepts and a mapping between terminologies and elements of different models, such that substituting the concept-specific terminology turns a statement about one concept into a statement about the other concept. The similarities in a duality enable cross-domain idea reuse. The duality between simulation models and RFLP can provide tremendous value to the RFLP process by providing automated simulation code generation and compatibility with strongly marketed simulation environments such as Modelica and Simulink. This duality can also be exploited to provide compatibility between RFLP tools and embedded and PLC code.

Logical models in RFLP can be naturally mapped to Topological models as used in commercial modeling products because these acausal physical modeling languages allow the modeler to concentrate on the physical interconnections of components. Functional Models in RFLP can be naturally mapped to mathematical models as used in commercial modeling products because both can be built on the principle of transforming inputs and states into outputs, and it includes the interconnection of these “functions.” Similarly, logical models can be mapped to topological models as used in commercial modeling products because both are built on the interconnection and energy exchange and conservation principles between components.

Both acausal models 212, such as acausal physical models, including but not limited to those used by Modelica and Simscape systems, and causal models 214, such as causal signal-flow models and others, including but not limited to those used in the Simulink system, can be converted by the system into numerical simulation model 220 for execution computer system. The difference is that transforming causal models 214 into numerical simulation models 220 is straightforward. On the other hand, converting acausal models 212 into numerical simulation models 220 is not trivial.

In some embodiments, the transformation of acausal physical models 212 into numerical simulation models uses a mathematical model 218 as an intermediate step, as illustrated by the dashed line, but this process can be hidden from the user. Acausal physical model 212 can be converted into a mathematical model 218 from which the numerical simulation model can be synthesized. This process is referred to herein as “causalization” of acausal models and is used for executing acausal models in a computer system. This process typically involves symbolic transformations to reduce the index of the differential algebraic equations in the acausal model, sorting the equations, tearing algebraic loops, etc.

Due to this causalization process, mathematical model 218 is a subset of topological models 216. In other words, causal languages (e.g. Simulink) can be considered a subset of acausal physical modeling languages (e.g. Modelica/Simscape). Disclosed embodiments can automatically generate behavior models 210 from logical models 206 and functional models 204. Simulation code (numerical simulation model 220) can be generated from functional models 204 through a mathematical model 218 since it is built on the principle of transforming inputs into outputs. Simulation code (numerical simulation model 220) can be generated from logical models through a topological model since it is built on the principle of interconnection between components and energy conservation between its ports. Various embodiments can convert topological models into simulation code by causalization.

Currently, RFLP tools focus on a static description of the system. On the other hand, Model-Based System Engineering (MBSE) tools focus on a dynamic simulation of the system. Disclosed embodiments can bidirectionally connect RFLP and MBSE tools using a language independent representation. In addition, various embodiments can automatically generate simulation code from logical models semantically connected to RFLP system representations.

Various embodiments can use a free-form diagramming tool to author and edit existing RFLP models. The specific format for storing RFLP models in the system is implementation-dependent, and therefore, some embodiments use a higher-level of abstraction to describe RFLP models in an implementation-independent, language-independent, and platform-independent form, which is a particular advantage of a free-form diagramming tool.

The RFLP model used herein can include several elements, such a representation of requirements (or requirements model). The requirements model can include customer requirements, functional requirements, non-functional requirements, etc. The requirements model can include formalized test cases to analyze measurable physical quantities and signals, a list of key performance parameters that will be monitored during the simulation to validate that the system meets the requirements, or use-cases and context for a given simulation (e.g. acceleration, deceleration, highway speed maneuvers, etc).

The RFLP model can include representation of functions that includes functional models that describe what the system is supposed to do. The functional models can include but are not limited to function and flow types (e.g. Convert Electrical Energy), primary and secondary flow information, interface definitions (i.e. ports and connector types), or function decomposition and hierarchy.

The RFLP model can include representation of logical models, which are the realization of how components are interconnected, with physical connectors, in a topological schematic view. The logical models can include but are not limited to interface definitions (i.e. ports and connector types), state variables initialization, parameter types and values, logical decomposition and hierarchy, or behavior definition and facets associated with logical components (e.g. to be used to generate the different simulation models).

The RFLP model can include representation of physical models, defining a detailed specification for fabrication including dimensions, shapes, and source code. The physical models can include but are not limited to geometry and dimensions, material density, kinematic information (i.e. joint types, functions, body information), mechanical ports, or part relationships (e.g. “connected-to”).

The RFLP model can include representation of architecture representing how the system is supposed to be organized, including modularity information. Architecture model can include but are not limited to mapping of functions to logical components, mapping of logical components to physical components, or possible alternatives when allocating local and physical components (e.g. configuration).

The RFLP model can include representation of behavior that describes the dynamics of a system or how the system evolves over time. Behavior can be continuous or discrete (events). Behavior models may be described by differential equations, mathematical formulas, state machines, block-flow diagrams, etc. The RFLP model can include but is not limited to semantic relations between the RFLP model including architecture and behavior. These semantic relations can be of various types including primitive types and user-defined types.

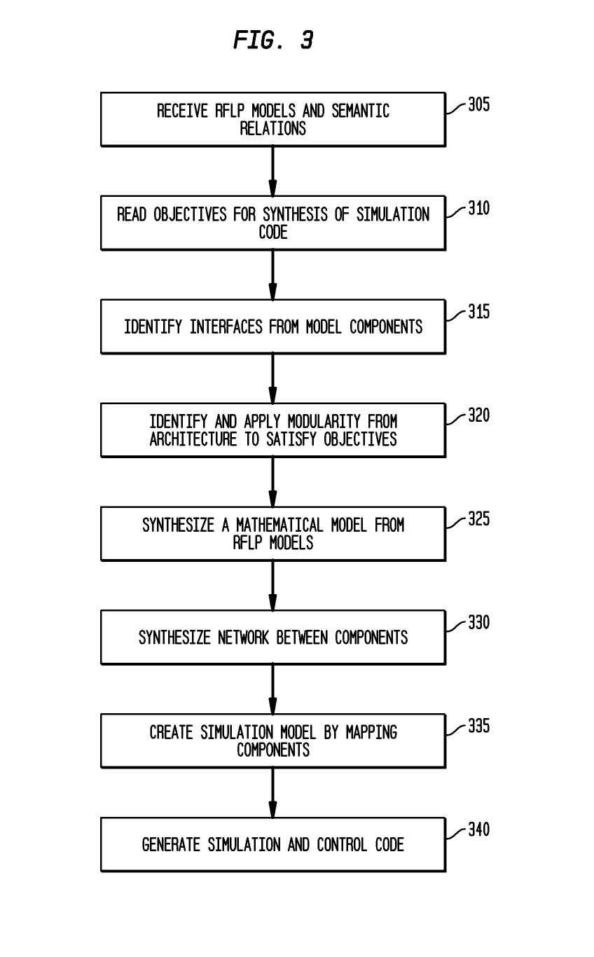

FIG. 3 depicts a flowchart of a process in accordance with disclosed embodiments that may be performed, for example, by one or more PLM or PDM systems, referred to generically as the “system” below.

The system receives systems engineering data to be simulated including a plurality of components (305). The systems engineering data can be RFLP models or semantic relations, as described above, where each model can include a plurality of components, or can be other systems engineering data or models. “Receiving,” as used herein, can include loading from storage, receiving from another device or process, receiving via an interaction with a user, or otherwise. The RFLP models can together represent, for example, a physical system, part, assembly, product, or mechatronic system.

The system receives objectives for the synthesis of simulation code (310). The objectives can describe, for example, the type of model to be simulated, the aspects to be simulated, or otherwise.

The system identifies interfaces from model components (315). The interfaces can include energy, material, and control/data transformations between components of the models.

The system identifies and applies modularity from the model architecture to satisfy the objectives (320). The modularity can describe the elements of the architecture to be simulated and how they are organized with relation to each other.

The system synthesizes a mathematical model from the systems engineering data, which can be the RFLP models (325).

The system synthesizes a network between the components (330). This can be performed according to the identified interfaces, the identified modularity, or the synthesized mathematical model. As part of synthesizing the network, the system can perform syntactic, sematic, or pragmatic checks of the relationships between components represented by the network.

The system creates a simulation model, based on the mathematical model or the network, by mapping the components of the network to a plurality of simulation components (335). One or more of the components of in the mathematical model or the network can be mapped to one or more simulation components in the simulation model, which can effectively combine the engineering data from different disciplines into the simulation components. The simulation model can be displayed, for example, as a geometric model comprising the simulation components that interact in the simulation as defined by the engineering data.

The system generates a simulation and control code according to the simulation model and the simulation components (340). The simulation can also be generated according to the received objectives. Generating the code can include generating Modelica-compatible code for physical simulations or high-fidelity simulations. Generating the code can include generating Simulink-compatible code for controller validation or real-time simulation. Generating the code can include generating programmable logic controller (PLC) code or embedded code for automation simulation. Generating the code can include generating queuing code for queuing simulations. Generating the code can include generating thermodynamic code for domain-specific simulations.

Disclosed embodiments automatically generate simulation models from systems engineering data, including requirements, functional, logical, and physical data in the RFLP models, and including mechatronic models. The system can test changes in the RFLP data through simulation immediately because simulation models can be automatically generated rather than manually created. This eliminates the time consuming and error prone process of manual model generation.

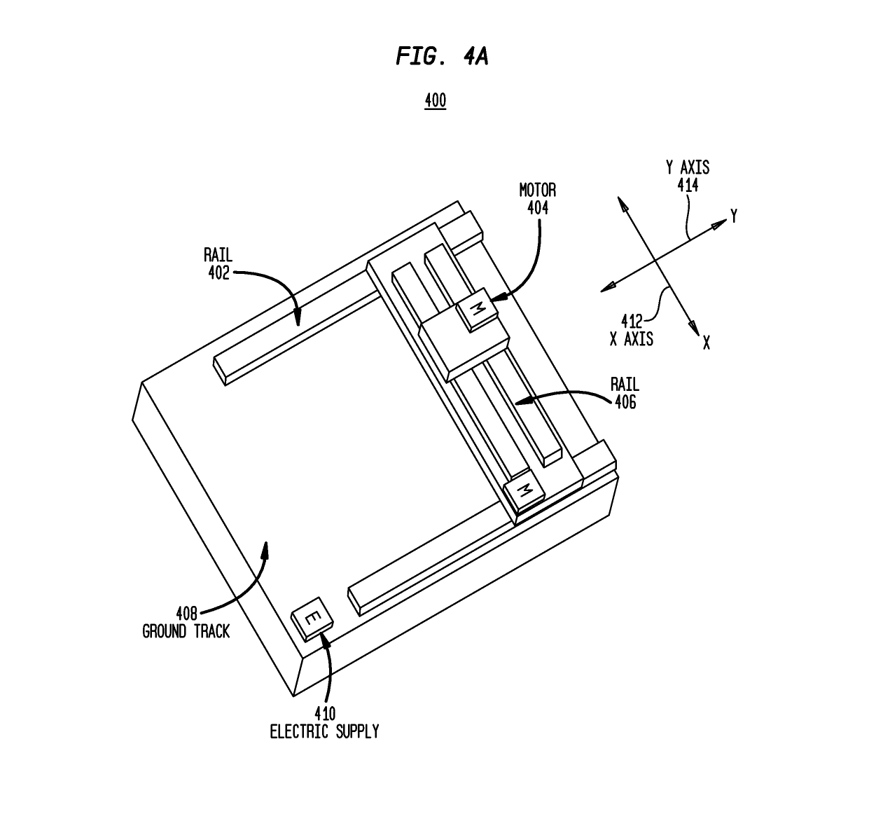

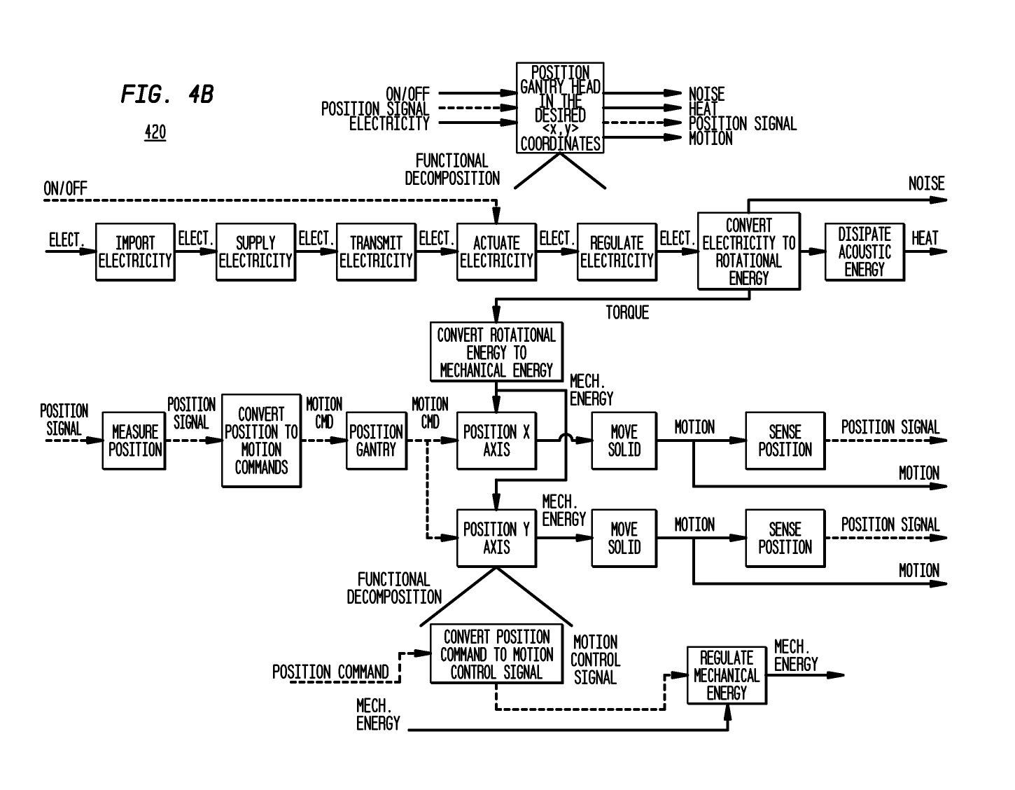

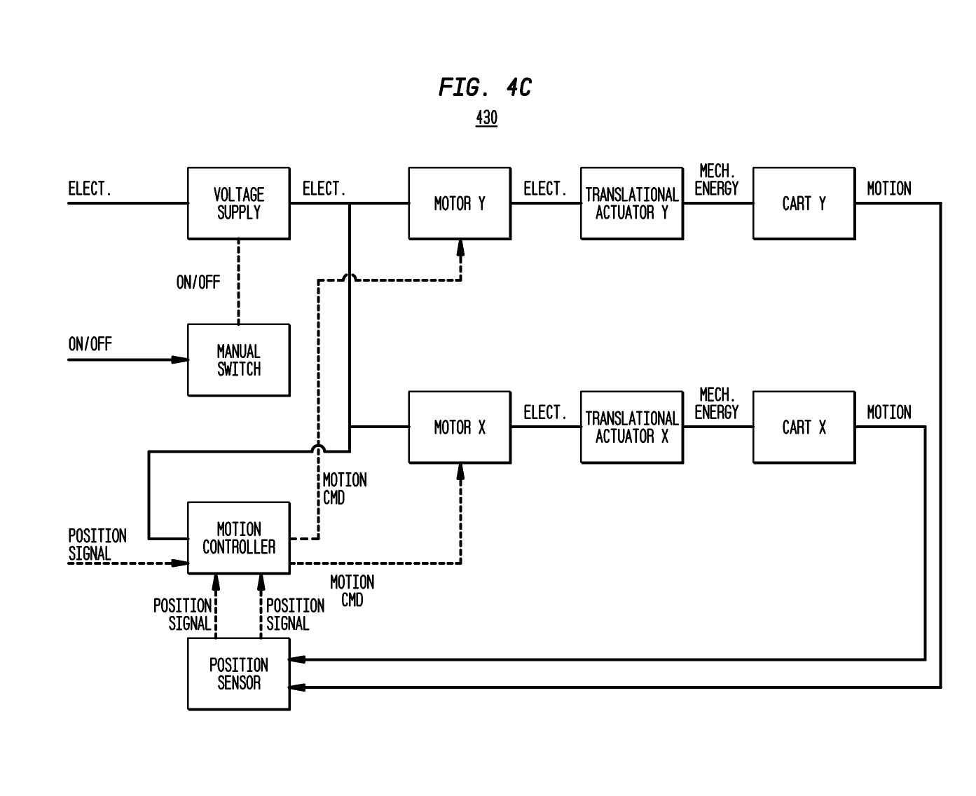

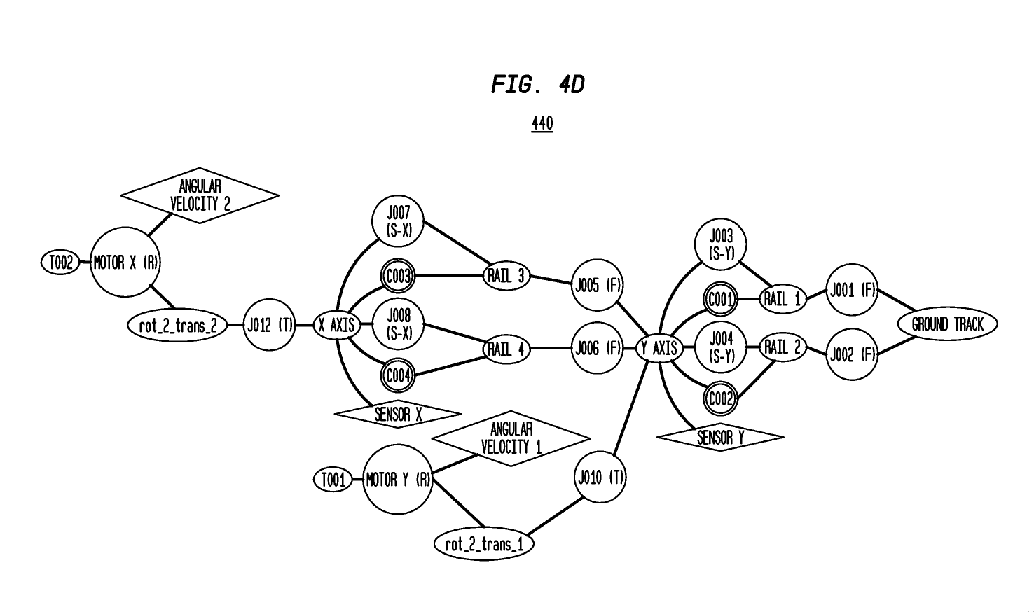

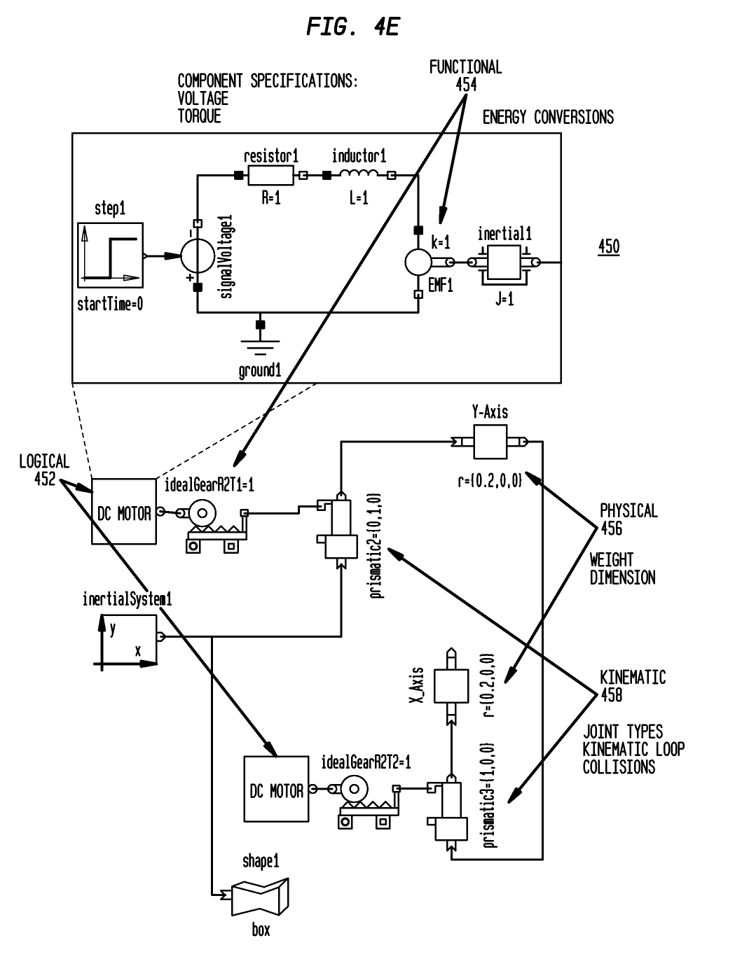

FIGS. 4A-4E illustrate examples of models in accordance with disclosed embodiments, including various components and the interfaces (connections) between them. FIG. 4A illustrates an example of a physical model 400 of a gantry that can be created and maintained in a CAD system. This physical model includes such features as rail 402, motor 404, rail 406, ground track 408, electric supply 410, x-axis designation 412 and y-axis designation 414. This physical model can also include such information as dimensions, weights, materials, friction coefficients, and others, and this information can also be considered requirements data where it correctly reflects the corresponding requirements. In this sense, model 400 can also act as a requirements model.

FIG. 4B illustrates an example of a functional model 420 that corresponds to the physical/requirements model of FIG. 4A. This figure illustrates functions performed by or to the gantry and the interfaces of electricity, commands, motion, mechanical energy, signals, and other elements that drive, control, or interact between the respective functions.

FIG. 4C illustrates an example of a logical model 430 that corresponds to the physical/requirements model of FIG. 4A. In this figure, the logical blocks of the gantry are illustrated, as are the interfaces between them including signals, electricity, motion, and energy.

FIG. 4D illustrates an example of a kinematic model 440 that corresponds to the physical/requirements model of FIG. 4A. In this figure, the movements performed by the gantry are illustrated, as elements such as the rails, motor, velocities, axes, etc., including the interfaces between them. The kinematic model also can function as a physical model with regard to the motion data and a requirements model to the extent that the represented movements reflect the requirements of the gantry.

FIG. 4E illustrates an example of a synthesized network model 450 illustrating connections between a plurality of components that corresponds to the models of FIGS. 4A-4D. This synthesized network model 450 includes elements from each of the other models, including logical elements 452, functional elements 454, physical elements 456, and kinematic elements 458, and the interfaces between the components or elements. This synthesized network model 450 can also include requirement and operational data; such data can include logical data such as voltage and torque component specifications, functional data such as energy conversions, physical data such as weights and dimensions, kinematic data such as joint types, kinematic loops, collisions, and other data that specifies requirements or operational specifications. The components in the synthesized network model 450 can then be used to create a simulation model including simulation components corresponding to one or more of the components in the synthesized network model 450. The simulation model could be displayed, for example, in a form similar to that of FIG. 4A.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for product data management, the method performed by a data processing system and comprising:
receiving systems engineering data including a plurality of components by the data processing system;
identifying interfaces from the plurality of components by the data processing system;
synthesizing a network between the plurality of components by the data processing system;
creating a simulation model, based on the network, by mapping the plurality of components to a corresponding plurality of simulation components by the data processing system; and
generating a simulation and control code according to the simulation model and the simulation components by the data processing system.

2. The method of claim 1, wherein the data processing system also receives objectives for synthesis of simulation code, and the control code is generated based at least in part on the objectives.

3. The method of claim 1, wherein the systems engineering data is requirements, functional, logical, and physical (RFLP) models, each including a plurality of components.

4. The method of claim 1, wherein the data processing system also identifies and applies modularity from a model architecture, and the simulation is generated at least in part based on the modularity.

5. The method of claim 1, wherein the network is synthesized based according to the identified interfaces, an identified modularity, or a synthesized mathematical model.

6. The method of claim 1, wherein the systems engineering data includes mechatronic models.

7. The method of claim 1, wherein the data processing system also synthesizes a mathematical model from the systems engineering data.

8. A data processing system comprising:
a processor; and
an accessible memory, the data processing system particularly configured to
receive systems engineering data including a plurality of components;
identify interfaces from the plurality of components;
synthesize a network between the plurality of components;
create a simulation model, based on the network, by mapping the plurality of components to a corresponding plurality of simulation components; and
generate a simulation and control code according to the simulation model and the simulation components.

9. The data processing system of claim 8, wherein the data processing system also receives objectives for synthesis of simulation code, and the control code is generated based at least in part on the objectives.

10. The data processing system of claim 8, wherein the systems engineering data is requirements, functional, logical, and physical (RFLP) models, each including a plurality of components.

11. The data processing system of claim 8, wherein the data processing system also identifies and applies modularity from a model architecture, and the simulation is generated at least in part based on the modularity.

12. The data processing system of claim 8, wherein the network is synthesized based according to the identified interfaces, an identified modularity, or a synthesized mathematical model.

13. The data processing system of claim 8, wherein the systems engineering data includes mechatronic models.

14. The data processing system of claim 8, wherein the data processing system also synthesizes a mathematical model from the systems engineering data.

15. A non-transitory computer-readable medium encoded with executable instructions that, when executed, cause one or more data processing systems to:
receive systems engineering data including a plurality of components;
identify interfaces from the plurality of components;
synthesize a network between the plurality of components;
create a simulation model, based on the network, by mapping the plurality of components to a corresponding plurality of simulation components; and
generate a simulation and control code according to the simulation model and the simulation components.

16. The computer-readable medium of claim 15, wherein the data processing system also receives objectives for synthesis of simulation code, and the control code is generated based at least in part on the objectives.

17. The computer-readable medium of claim 15, wherein the systems engineering data is requirements, functional, logical, and physical (RFLP) models, each including a plurality of components.

18. The computer-readable medium of claim 15, wherein the data processing system also identifies and applies modularity from a model architecture, and the simulation is generated at least in part based on the modularity.

19. The computer-readable medium of claim 15, wherein the network is synthesized based according to the identified interfaces, an identified modularity, or a synthesized mathematical model.

20. The computer-readable medium of claim 15, wherein the systems engineering data includes mechatronic models, and the data processing system also synthesizes a mathematical model from the systems engineering data.
